(19) United States
(12) Patent Application Publication
(10) Pub. No.: US 2016/0338409 A1
(43) Pub. Date: Nov. 24, 2016

(54) TACTICAL ELECTRONIC CIGARETTE

(71) Applicant: Rick Varone, Smithtown, NY (US)

(72) Inventor: Rick Varone, Smithtown, NY (US)

(21) Appl. No.: 14/717,571

(22) Filed: May 20, 2015

(51) Int. Cl. A24F 47/00; F21V 33/00

(52) U.S. Cl. CPC A24F 47/008; F21V 33/0004

(57) ABSTRACT

An electronic cigarette configured not to simulate at either end the lighted end of a conventional electronic cigarette is disclosed. The electronic cigarette comprises a translucent or non-translucent conduit housing internal components within the conduit. These internal components comprise: a unit containing liquid; a vaporizing unit for vaporizing the liquid within the unit containing liquid; a power source; an integrated circuit positioned within a distal end of the conduit; an end piece coupled to the distal end of the wherein no light chamber is illuminated when the electronic cigarette is inhaled or exhaled. In another preferred embodiment, the present invention is directed to an electronic cigarette to be used in a military vertical market space designed for saving the lives of military personnel that desire to smoke as opposed to the social vertical market space where lighted E-Cigarettes are commercially used and sold.

### TECHNICAL FIELD

The present invention relates to electronic cigarettes, and more particularly, to an electronic cigarette configured not to simulate the lighted end of a conventional electronic cigarette.

### BACKGROUND OF THE INVENTION

Electronic cigarettes have recently been developed and generally comprise a battery-powered device that provides inhaled doses of nicotine or non-nicotine vaporized solutions. It is an alternative to smoking tobacco products such as cigarettes in addition to providing nicotine delivery.

Generally speaking, when a user inhales an electronic cigarette, air flow is detected by a sensor which activates a heating element which vaporizes a liquid solution stored in the electronic cigarette. A conventional e-cigarette includes lighting means at one end such as an L.E.D. to simulate the burning end of a traditional cigarette, and houses a battery, an atomizer and a cartridge. In some e-cigarettes, the cartridge and atomizer are combined into one known as a cartomizer.

However, the use of a conventional e-cigarette by military personnel on combat duty such as night patrol or night watch that desire an e-cigarette faces the possibility of being shot at by snipers spotting the lighted end of the e-cigarette. Therefore, a need exists, to provide all the features of an e-cigarette without a lighted end. The present invention solves this problem as it pertains to combat missions in war zones were sniper fire presents a clear and present danger.

### SUMMARY

An electronic cigarette configured not to simulate at either end a lighted end of a conventional electronic cigarette is disclosed. The electronic cigarette comprises a translucent or non-translucent conduit housing internal components within the conduit. These internal components comprise: a unit containing liquid; a vaporizing unit for vaporizing the liquid within the unit containing liquid; a power source; an integrated circuit positioned within a distal end of the conduit; an end piece coupled to the distal end of the wherein no light chamber is illuminated when the electronic cigarette is inhaled or exhaled. The electronic cigarette of the present invention will save lives for military personnel in combat area that still desire to have a smoke.

In another preferred embodiment of the present invention is an electronic cigarette designed to be used in a military vertical market space as to not to compete within the social vertical market space where lighted E-Cigarettes are commercially used and sold wherein the military vertical market is defined as all the branches of the Armed Forces, namely; the Navy, Army, Marines, Coast Guard, National Guard and Special Ops etc.

In yet another preferred embodiment of the present invention is an electronic cigarette designed to be used in the photography industry dark rooms where no light is allowed, but the photographer developer still wants to have a smoke.

### BRIEF DESCRIPTION OF THE DRAWINGS

The novel features believed to be characteristic of the application are set forth in the appended claims. The novel features believed to be characteristic of the application are set forth in the appended claims. In the descriptions that follow, like parts are marked throughout the specification and drawings with the same numerals, respectively. The drawing figures are not necessarily drawn to scale and certain figures can be shown in exaggerated or generalized form in the interest of clarity and conciseness. The application itself, however, as well as a preferred mode of use, further objectives and advantages thereof, will be best understood by reference to the following detailed description of illustrative embodiments when read in conjunction with the accompanying drawings, wherein:

FIG. 1 is a cross-sectional side view of an electronic cigarette in accordance with the present invention;

FIG. 2 is a side view of wrapper being coupled to a conduit of an electronic cigarette in accordance the present invention;

FIG. 3 is a side view of an electronic cigarette in accordance the present invention;

FIG. 4 is an exploded perspective view of a conduit, integrated circuit, and housing of an electronic cigarette in accordance with the present invention;

FIG. 5 is a perspective view of a housing used with an electronic cigarette in accordance with the present invention;

FIG. 6 is a side view of an electronic cigarette in accordance with the present invention; and

FIG. 7 a porous membrane filter of an electronic cigarette in accordance with one or more embodiments of the present invention.

### DESCRIPTION OF THE PREFERRED EMBODIMENTS

The description set forth below is intended as a description of presently preferred embodiments of the disclosure and is not intended to represent the only forms in which the present disclosure can be constructed and/or utilized. The description sets forth the functions and the sequence of steps for constructing and operating the disclosure. It is to be understood, however, that the same or equivalent functions and sequences may be accomplished by different embodiments that are also intended to be encompassed within the spirit and scope of this disclosure.

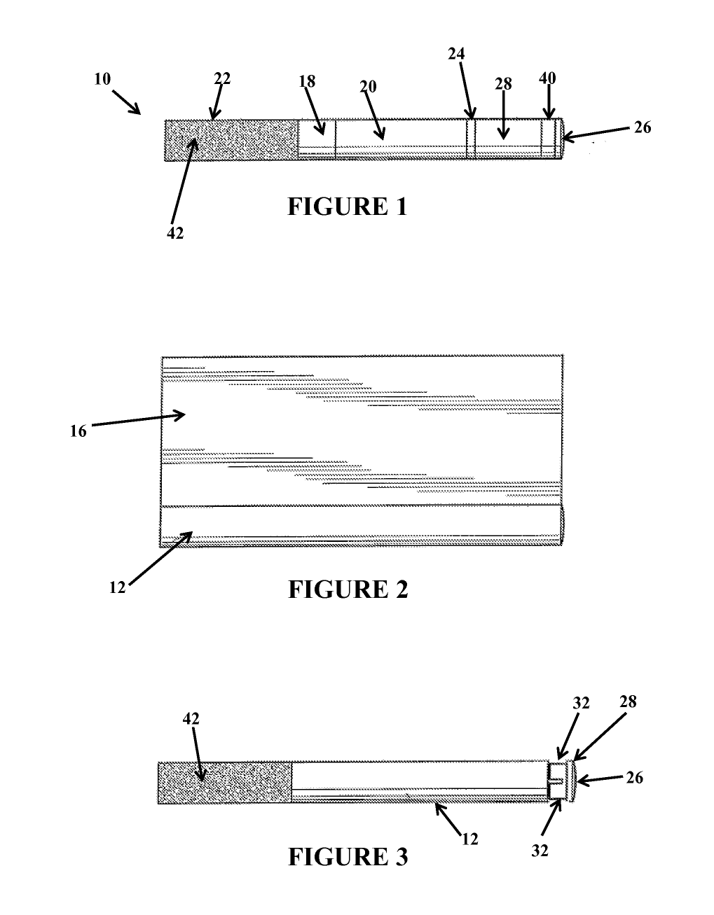

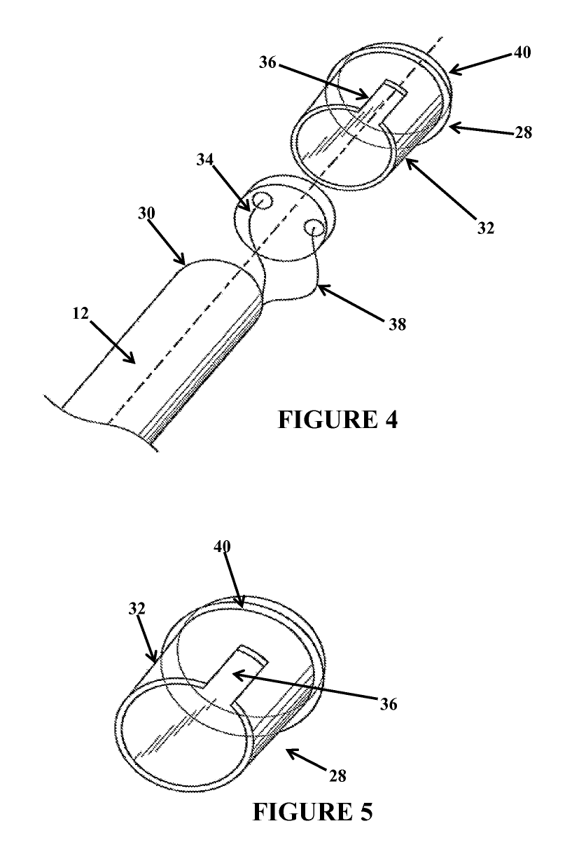

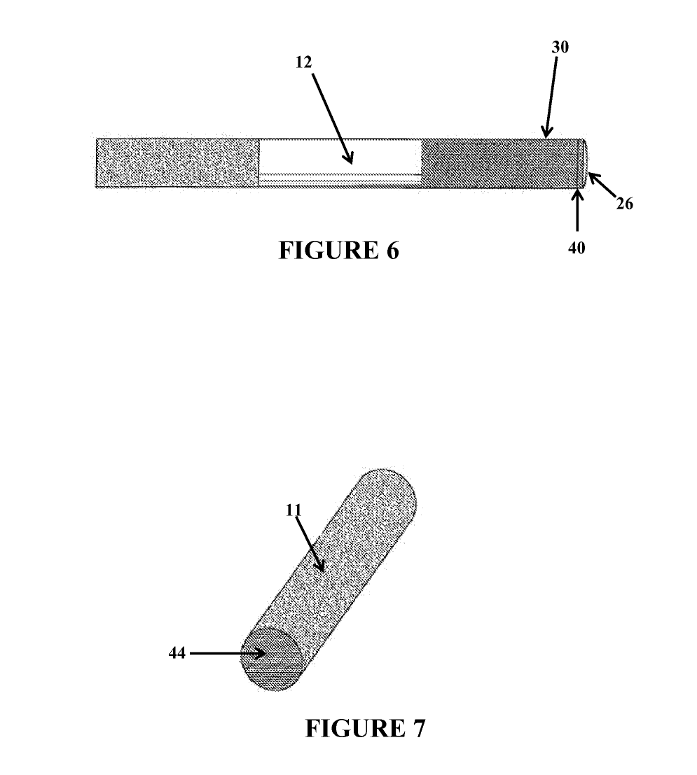

Referring now to FIGS. 1 through 7, an electronic cigarette 10 that does not simulate the natural burn of a traditional cigarette is disclosed. The electronic cigarette 10 comprises a non-translucent conduit for protecting and housing its internal components and in one preferred embodiment include a number of components consisting of a power source such as a battery, a sensor, vaporizing unit, and a unit containing liquid that contains nicotine. The battery may be a pre-charged, disposable type of device that is not rechargeable or, alternatively, a rechargeable battery. The unit containing liquid may be cotton or some other suitable absorptive fiber that is saturated with liquid, wherein the unit containing liquid surrounds the vaporizing unit within the non-translucent conduit 12. The vaporizing unit comprises a heating element wrapped about a wick, wherein the wick absorbs liquid from the surrounding unit containing liquid. In use and upon inhalation by a user, negative pressure causes the sensor to turn on the heating element, which then causes the liquid absorbed by the wick to vaporize and exit the electronic cigarette through an air tube.

Turning once again to FIGS. 1 through 7, there is shown an electronic cigarette 10 in accordance with the present invention. As described above, the electronic cigarette comprises a non-translucent conduit 12 wherein the non-translucent conduit 12 may be fabricated from metals or plastic, such as polyvinyl chloride (PVC), polyethylene, polypropylene, polycarbonate, or other suitable material that are non-translucent. As shown in FIG. 2, the conduit 12 may extend the entire length of the electronic cigarette 10 wherein conduit 12 may be covered with a wrapper 16 constructed of paper or suitable material. As shown in FIG. 1, the conduit 12 covers the components of the electronic cigarette 10, namely: vaporizing unit 18, battery 20, a unit containing liquid 22, integrated circuit 24, and end piece 26. The conduit 12 may also cover a portion or the entirety of a filter 11 shown in FIG. 7 and as more fully described below.

Referring now to FIGS. 3 through 5, in another embodiment, the electronic cigarette 10 further comprises a housing 28 that may be inserted into the distal end 30 of the conduit 12. The housing 28 may be cylindrical and have an outside diameter smaller than the inside diameter of the conduit 12 so that a proximal end (or shaft 32) of the housing 28 may be inserted into and frictionally engage the inside surface of the conduit 12 at the distal end 30 of the electronic cigarette 10. The shaft 32 of the housing 28 may have an inside diameter larger than the outside diameter of integrated circuit 34 so that the integrated circuit 34 may be held securely within the shaft 32 of the housing 28. The shaft 32 of the housing 28 may also define a notch 36 to accommodate for any wires 38 coupling the integrated circuit 34 to battery 20. By positioning the wires 38 within the notch 36, the housing 28 and wires 38 may rest flush against the inner surface of conduit 12 at the distal end 30 of the electronic cigarette 10 when the shaft 32 of the housing 28 is inserted into the conduit 12. The end piece 26 of the electronic cigarette 10 may also be coupled to a distal end 30 of the housing 28. The housing 28 may also have an annular flange 40 that has the same outside diameter as the outside diameter of the conduit 12, so that when the shaft 32 of the housing 28 is inserted into the conduit 12, the annular flange 40 abuts the distal edge 42 of the conduit 12, allowing for a smooth continuous surface from the filter 11, through the length of the conduit 12, and the housing 28, and finally to the end piece 26. In another embodiment, the conduit may have a degree of or allows for multiple areas of varying degrees of translucency, as long that in accordance with the preferred embodiment of the present invention, no light is simulated at either end of electronic cigarette 10.

A filter 11 replicating that used in traditional cigarettes may be used with the present electronic cigarette 10. In previous configurations, the filter 11 has always had a hole for allowing smoke/vapor to pass there through. The filter 11 of the present invention may be fully enclosed. A porous membrane 44, porous molded disc, acidic fiber, or the like may be used to allow enough of the vapor to pass through simulating the amount of sucking required by the user to mimic a traditional cigarette filter.

What is claimed is:

1. A tactical electronic cigarette comprising:
a conduit adapted to contain internal components of an electronic cigarette device;
an integrated circuit positioned within the distal end of the conduit;
a housing for securing the integrated circuit within the distal end of the conduit, wherein at least a portion of the housing is translucent and wherein the housing comprises:
a shaft portion for insertion into the distal end of the conduit;
an annular flange that abuts the distal edge of the conduit; and
a notch defined by the shaft of the housing, the notch adapted to receive wires connected to the integrated circuit; wherein when the electronic cigarette is inhaled no light source is activated.

2. A tactical electronic cigarette comprising;
a translucent conduit;
internal components housed within the conduit, the internal components comprising:
a unit containing liquid;
a vaporizing unit for vaporizing the liquid within the unit containing liquid;
a power source;
an integrated circuit positioned within a distal end of the conduit;
an end piece coupled to the distal end of the conduit;
a translucent housing for receiving the integrated circuit and securing the integrated circuit within the distal end of the conduit wherein the housing comprises:
a shaft portion for insertion into the distal end of the conduit;
an annular flange that abuts a distal edge of the conduit; and
a notch defined by the shaft of the housing, the notch adapted to receive wires connecting the integrated circuit to the power source;
wherein the electronic cigarette is inhaled and exhaled no light source is activated.

3. The electronic cigarette of claim 2 further comprising a porous membrane filter coupled to a proximal end of the conduit.

4. The electronic cigarette of claim 2 further comprising a non-translucent conduit.

5. The electronic cigarette of claim 2 wherein a translucency for a light chamber is not provided and said conduit never lights up on either end.

6. An electronic cigarette comprising:
a translucent conduit;
internal components housed within the conduit, the internal components comprising:
a unit containing liquid;
a vaporizing unit for vaporizing the liquid within the unit containing liquid;
a power source;
an integrated circuit positioned within a distal end of the conduit;
a translucent ash simulator coupled to the distal end of the conduit;
a translucent housing comprising:
a shaft portion inserted into the distal end of the conduit, the shaft portion for receiving the integrated circuit;
an annular flange that abuts a distal edge of the conduit; and
a notch defined by the shaft of the housing, the notch adapted to receive wires connected to the integrated circuit;
wherein when the electronic cigarette is inhaled and exhaled no light source is activated.

7. The electronic cigarette of claim 6 further comprising a non-translucent conduit.

8. The electronic cigarette of claim 6 wherein a translucency for a light chamber is not provided and said conduit never lights up on either end.

9. The electronic cigarette of claim 1 wherein the electronic cigarette is designed to be used in a military vertical market space as opposed to a social vertical market space where a lighted electronic cigarette is commercially sold.

10. The electronic cigarette of claim 1 wherein the electronic cigarette is designed to be used by photography developers in photographic darkrooms.
